(19) United States
(12) Patent Application Publication
(10) Pub. No.: US 2024/0001172 A1
(43) Pub. Date: Jan. 4, 2024

(54) WEARABLE AIR PURIFIER

(71) Applicant: Dyson Technology Limited, Wiltshire (GB)

(72) Inventors: Thomas Scott MIDDLETON, Swindon (GB); James Murray ORCHARD, Bath (GB)

(73) Assignee: Dyson Technology Limited, Wiltshire (GB)

(21) Appl. No.: 18/038,174

(22) PCT Filed: Nov. 5, 2021
(86) PCT No.: PCT/GB2021/052876

§ 371 Date: May 22, 2023

(30) Foreign Application Priority Data
Dec. 3, 2020 (GB) 2019052.6

(51) Int. Cl. A62B 18/00; A62B 18/08; H04R 1/10

(52) U.S. Cl. CPC A62B 18/003; A62B 18/084; H04R 1/1066; H04R 1/1008; H04R 1/105

(57) ABSTRACT

A wearable air purification system or air purifier including a wearable support configured to be supported on a head region of a user and having a first end connected to a first audio earpiece and a second end connected to a second audio earpiece; an air delivery mask in the form of an elongated bar that includes first and second ends connected to the wearable support and which is shaped to bound an air delivery region and to deliver a flow of air to the air delivery region. The wearable support and the air delivery mask include a respective flexible region which allows both the wearable support and the air delivery mask to fold into a compact configuration.

### TECHNICAL FIELD

The disclosure is directed to improvements relating to wearable air purification systems or ‘purifiers’.

### BACKGROUND

We are all becoming more aware of air quality issues, particularly in larger urban areas but also more generally when in public areas where space between individuals may be limited, such as on public transport. Air quality issues may embrace various types of airborne pollutants such as potentially toxic gases and pollen, to name a couple of examples.

The wearing of various forms of face mask as a means to provide some level of protection against at least one form of airborne pollutants and toxins has generally become more accepted. However, usually such masks are passive and are configured simply as a single layer or multilayer assembly of material which is secured to the face of a user by an adjustable strap of some sort. Some people prefer to wear more complicated masks and respirators which offer a more comprehensive filtering functionality, but this usually comes at the expensive of comfort and style. They also are a barrier to clear communication.

Various approaches are apparent in the art that are intended to provide a similar or better level of air purification functionality, but which don't require a user to completely obscure their nose and mouth area by a tight-fitting mask. For example, one approach involves a wearable support such as a neckband or headband to which is attached a bar-like mask or visor which stretches around in front of the mouth and delivers a jet of filtered air. Such approaches show some promise over conventional fabric masks, but they still tend to obscure the user's facial features significantly. They also tend to be bulky which can sometimes be seen as limiting their practicality as an object for daily wear. The current disclosure is direct to addressing at least some of these challenges.

### SUMMARY OF THE INVENTION

According to a first aspect of the invention, there is provided a wearable air purification system comprising a wearable support configured to be supported on a head region of a user and having a first end connected to a first audio earpiece and a second end connected to a second audio earpiece; an air delivery mask in the form of an elongated bar that includes first and second ends connected to the wearable support and which is shaped to bound an air delivery region and to deliver a flow of air to the air delivery region. The wearable support and the air delivery mask include a respective flexible region which allows both the wearable support and the air delivery mask to fold into a compact configuration.

Beneficially therefore, the invention provides a particularly convenient wearable air purifier product which can convert from an ‘in use’ configuration in which it is suitable to be worn by a user, and a folded or storage configuration in which the product takes up less space. It can therefore be stowed in a bag or dedicated carrying case in a smaller volume.

In a particularly flexible configuration, the first and second ends of the wearable support are connected to the first and second audio earpieces by respective movable couplings. The ear pieces are therefore able to flex or rotate with respect to the wearable support, which provides additional folding options.

The flexible regions may be defined in various ways. In one example, the flexible region of the wearable support may be defined approximately in the middle of its length. Similarly, the flexible region of the air delivery mask may be defined in the middle of its length. The flexible regions may be any suitable type of hinged forms, such as rotating hinges or so-called ‘living hinges’ in which the flexible region of either the wearable support or the mask as the case may be is relatively more flexible than the surrounding portions.

In the case of the air delivery mask which may be structed to define an internal air duct, the flexible region may also define part of the air duct, which ever form of hinge structure it has.

In one example the air delivery mask is connected to the wearable support via the first and second audio earpieces. This provides a particularly convenient structure for the product. However, other examples are configured where the mask is connected directly to the wearable support.

When coupled to the earpieces, the air delivery mask may be coupled thereto by a suitable moveable coupling which allows the air delivery mask to pivot with respect to the earpiece. Preferably, such movable couplings may define air channels to allow air to be ducted from the earpieces into the air delivery mask.

Although in various examples the flexible region of the air delivery mask is located in approximately its centre, in other examples the flexible region may be located towards one or both of its ends. This provides different options for how the mask can fold.

Furthermore, although the flexible regions may be defined by discrete hinge points, in other examples, the flexible regions may extend along a predetermined length of the mask, for example along 30% or 50% of the length of the mask.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

The above and other aspects of the invention will now be described, by way of example only, with reference to the accompanying drawings, in which:

FIG. 1 is a perspective view of an example of a personal air purifier in which examples of the invention may be applied;

FIG. 2 is a perspective view of an air delivery mask or visor which is part of the air purifier in FIG. 1;

FIG. 3 is an internal view of an earpiece of the air purifier of FIG. 1;

FIG. 4a-d are a sequence of views showing the folding operation of an example of the air purifier;

FIGS. 5 and 6 are schematic views of example hinge schemes for the air purifier; and

FIGS. 7a-c and FIGS. 8a-b are schematic views of sequential folding actions of two other examples of the air purifier of the invention.

Note that features that are the same or similar in different drawings are denoted by like reference signs.

### Specific Description

Examples of the invention will now be described in detail in order to provide a thorough understanding of the inventive concept as defined in the claims. However, it will be apparent to the skilled person that the invention may be put into effect without the specific details and that in some instances, well known methods, techniques and structures have not been described in detail in order not to obscure the invention unnecessarily.

In overview the invention provides a wearable product or item that combines audio functionality and personal air purification into a convenient stowable package. The product, which will now be referred to as an air purifier, is configurable between a wearable configuration and a storage or ‘folded’ configuration in which the product adopts a much more compact package which takes up less room, either in a carrying case, rucksack, handbag or otherwise. In the wearable configuration the user wears the purifier on or around the head to enjoy a ready source of clean filtered air and, optionally, a source of music or other audio input. Conventional wearable air purifiers, particularly ones which combine purification and an audio system, tend to be rather bulky, which compromises proper portability of the product, so the examples of the invention provide a convenient and elegant solution. Further features and advantages will become apparent from the discussion that follows.

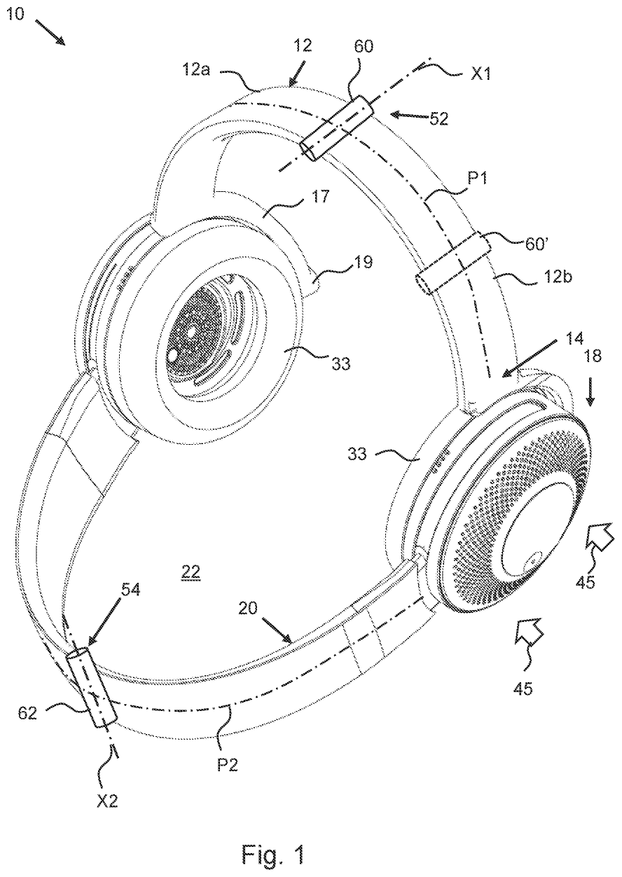

FIG. 1 shows a wearable air purifier 10 to which the examples of the invention relate. The air purifier 10 shown here is very similar to devices disclosed in prior publications belonging to the applicant, such as GB2582372 and WO2020021231. A full discussion of the air purifier will not be provided here for brevity, but a summary is provided below for completeness.

The wearable air purifier 10 is configured to be worn on a user's head, like a conventional set of headphones. For this purpose, therefore, the wearable air purifier 10 comprises a wearable support or ‘headband’ 12 having first and second ends 14,16 which are connected to respective audio earpieces or ear cups 18. The earpieces 18 are coupled to the headband 12 by a conventional movable or rotatable coupling, embodied here by an arcuate arm 17 that extends about a portion of a respective earpiece 18 and engages with that earpiece 18 by a rotational pivot pin 19. Further discussion of this coupling will be omitted for brevity.

The earpieces 18 provide the dual functionality of providing audio playback and a purified air flow. The audio play back functionality is provided by a suitable speaker system provided in the earpieces 18 and the air flow is provided by a suitable airflow generator or compressor which is integrated in the earpieces, in this example. At this point, it should be noted that in other examples of the invention it is envisaged that the air flow generation may be separated from the earpieces.

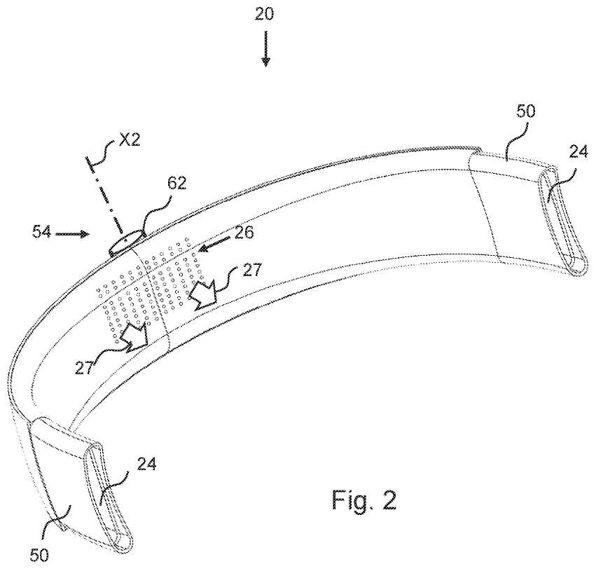

The air purifier 10 also comprises a curved air delivery mask or visor 20 that extends forward of the headband 12 and the earpieces 18 so as to embrace and define an air delivery region 22. In this example, the air delivery mask 20 is elongated and bar-like in form and is made from a rigid plastics material such as polycarbonate, although this is just optional. As seen in FIG. 2 more clearly, the air delivery mask 20 includes suitable airflow pathways, ducts and channels 24 that convey a flow of air from the compressor along the air delivery mask 20 and direct it towards the user's mouth through at least one nozzle 26. The at least one nozzle 26 may be embodied by a grille or array of holes, as is appropriate. The flow of air is indicated here as ‘27’.

Although in this example the air purifier 10 is designed such that the wearable support fits of the head of a user, it is envisaged that this need not be the case and that in some examples the wearable support may fit around the back of the head or even around the neck area. For the purposes of this discussion, however, the wearable support will be referred to generally as a ‘headband’, although this should be interpreted as extending to similar bands, straps or similar structures that fit around or onto other parts of the head area of the user.

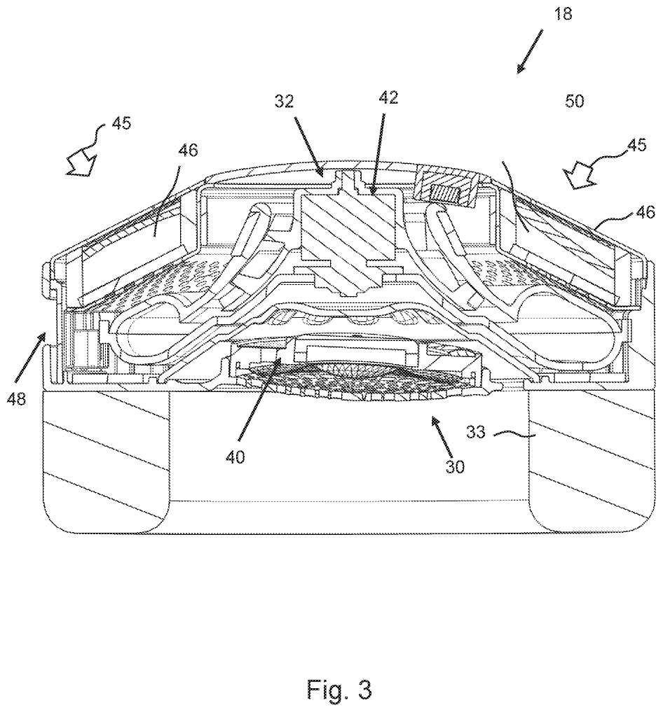

The pair of audio earpieces 18 are generally identical in this example, and a cross section through one of the earpieces 18 is shown in FIG. 3. In order to provide dual audio and air flow functionality the earpiece 18 as shown comprise a speaker assembly 30 at a radial inward position and a compact air purifier unit 32 at a radially outer position. Here, the terms radially “inner” and “outer” are taken with respect to the head of a user on which the air purifier is worn. An ear pad 33 is provided to provide a soft cushioned interface for the user's ear.

The speaker assembly 30 includes a speaker unit 40 comprising a speaker and speaker electronics. A Bluetooth or other type of wireless communication transmitter/receiver may be provided for wireless communication with an audio playing device. The speaker unit 40 and the air purifier unit 32 may share a battery pack and part of the control electronics (not shown here).

The air purifier unit 32 comprises an airflow generator or compressor 42 for drawing in air through its the annular inlet 44 at the outer surface of the earpiece 18. The incoming air 45 is filtered by a filter 46 near the inlet 44 of the air purifier unit 32. The compressor 42 compresses the incoming air 45 that is then expelled from the earpiece 18 through a connector 48 that serves to couple the air delivery mask 20 to the respective earpiece 18. Operation of the compressor 42 therefore draws air into the earpiece 18 and forces it into the air delivery mask 20 and out through the nozzles 26 so as to provide a flow of fresh air to the user.

The connector 48 is shown here as a generally rectangular port that is shaped so as to receive a respective end of the air delivery mask 20 that defines a cooperating plug or connector 50. As can be seen in FIG. 2, those respective ends are also rectangular in form, but having a slightly smaller geometry so that they are receivable by the respective connectors 48 in the earpieces 18.

In this example, the connectors 50 of the air delivery mask 20 are male ends that fit into the female ends or sockets provided by the connectors 48 of the earpieces 18. The coupling between the ends of the air delivery mask 20 and the connectors 48 of the earpieces 18 may be flexible to allow for a degree of pivoting or swivelling of the air delivery mask 20 with respect to the earpieces. For example, the end connectors 50 of the air delivery mask may be formed from a short section of flexible hose, e.g. of silicone rubber. Although not shown here, the coupling may also be embodied by a rotational joint to allow the air delivery mask 20 to pivot rotationally downwards out of the way of the user's mouth.

When considering the air purifier 10 shown in FIG. 1, it will be appreciated that the device is shown in the wearable configuration as it would be when worn on the head of a user. In this configuration, the headband and the air delivery mask extend in approximately orthogonal directions away from the earpieces 18. Referring to each earpiece 18, therefore, the connection with the headband 12 is approximately at the 3 o-clock position, by virtue of the pivot pin 19, whilst the main section of the headband 12 extends away from the earpiece 18 at the 12 o'clock position, and the connection with the air delivery mask 20 is approximately at the 9 o'clock position. Although this configuration is beneficial in terms of supporting the air purifier on the user and providing a flow of fresh air to where it is needed, the resultant package size of the product is quite large and so storing it in a bag or pouch when not in use may be problematic.

To address this issue, the air purifier can be folded down into a more compact configuration. As is illustrated in FIG. 1, each of the headband 12 and the air delivery mask 20 is provided with a respective flexible region 52,54 which, in effect, enables them to pivot.

The flexible regions 52,54 can be configured in various different ways, and various options will now be discussed. From a broad perspective, however, the flexible regions 52,54 enable the relatively rigid members of the headband 12 and the air delivery mask 20 to fold along their axes.

FIGS. 1 and 2 shown one option. Here, the flexible regions 52,54 and embodied by a rotational hinge, which is shown here schematically as a type of barrel hinge, and which would be well understood by a skilled person.

Considering the headband 12, its flexible region 52 being a rotational hinge 60 effectively divides the headband 12 into two portions or ‘arms’, shown here as 12a and 12b, which are pivotable in relation to one another. In the illustrated example, the hinge 60 is located approximately in the middle of the headband 12 when considered along its length. Each of the headband portions 12a,b therefore are the same length and are approximately 50% of the length of the headband. Locating the hinge 60 in the middle of the headband 12 provides for an even fold, but this configuration is not essential. For example, the hinge 60 may be located towards one end of the headband 12, as is shown by the dashed line version of the hinge marked as 60′. This would result in an uneven fold, but this could be useful depending on the desired packaging requirements because it would allow one of the earpieces 18 to sit against the underside of the headband 12.

In the illustrated example, the headband 12 is curved in the usual way and therefore extends in a plane, which is marked on FIG. 1 as P1. Moreover, the hinge 60 is oriented so that the rotational axis of the hinge, marked as X1, extends substantially perpendicularly to the plane P1 of the headband. By virtue of this relationship, the two headband arms 12,12b fold about the hinge 60 to as to swing angularly in the plane P1.

The arrangement of the headband 12 and the hinge 60 may be different to what is shown here, however. For example, the rotational hinge 60 may extend at an oblique angle to the headband plane P1 which would provide a different folding configuration for the headband 12.

As discussed above, in a similar way to the headband 12, the air delivery mask 20 is also provided with a respective flexible region 54 which allows it to fold. The flexible region 54 may be positioned on various locations along the length of the air delivery mask 20, but in the illustrated example the flexible region 54 is shown in the middle. Here, the flexible region 54 is also embodied as a rotation hinge 62. In this case, the rotational hinge 62 has a hinge axis X2 which is oriented so that it is substantially perpendicular to a plane P2 that is defined by the curved shape of the air delivery mask 20.

In the same way as the headband 12, therefore, the rotational hinge 62 of the air delivery mask divides the mask into two equal parts that are movable angularly with respect to one another about the axis X2 of the hinge 62. Usefully, this also helps to accommodate various head sizes since the hinge 62 makes it easy for the air delivery mask 20 to flex to accommodate different distances between the opposed earpieces 18.

Although in this embodiment the hinge 62 of the air delivery mask 20 is located in the middle, this is not essential and it could be positioned in a different location, towards one end of the mask 20, for example. Similarly, although the hinge axis X2 is perpendicular to the mask plane P2 in the illustrated embodiment, the hinge axis X2 could be angled differently.

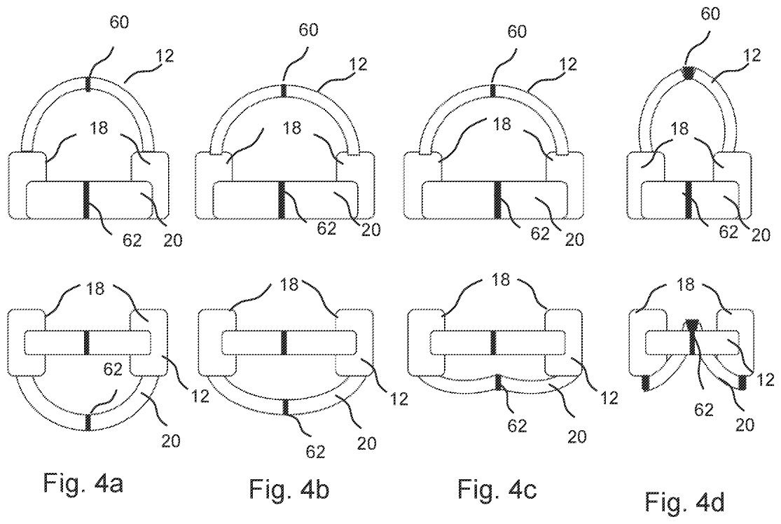

From the above discussion it will be appreciated that the hinged headband 12 and air delivery mask 20 complement one another since they move together to allow the air purifier to be configured into a more compact form, which could be considered a ‘stowed’ or ‘storage’ configuration. This is demonstrated in a visual form in FIGS. 4a-d, which show a series of views of the air purifier from the top (bottom row of images) and from the front (top row of images) as the air purifier is moved from a wearable configuration (in FIG. 4a) to a storage configuration (in FIG. 4d).

It is to be noted at this point that the air purifier shown in the upper images displays some aesthetic differences from the previously illustrated examples, but the principle of operation is consistent.

Comparing FIG. 4d to FIG. 4a, it will be appreciated that the air delivery mask 20 has been folded in on itself so that it sits between the earpieces 18. Due to the curvature of the mask 20 in the wearable configuration, folding movement of the mask 20 causes the earpieces 18 to splay outward slightly before folding inwards again, as can be appreciated by comparing FIGS. 4b and 4c.

Once the air delivery mask 20 has started to be folded, the headband 12 may then also be compacted in order to place the air purifier into the storage configuration, as shown in FIG. 4d.

It should be appreciated that the hinges 60,62 of the headband 12 and the air delivery mask 20 may be equipped with suitable locks or detents in order to releasable lock the air purifier into the wearable configuration which would provide the product with a suitable feel of solidity. A suitable unlocking mechanism could be provided to unlock the product so it could be folded, or it is envisaged that the hinges could be equipped with detents having a suitable release force such that the headband 12 and the air delivery mask 20 would only start to fold once sufficient force has been applied.

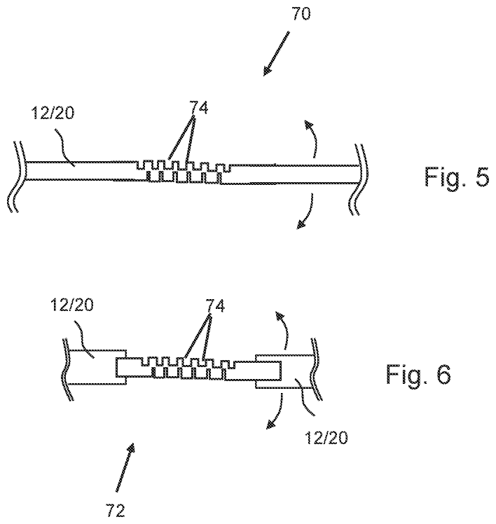

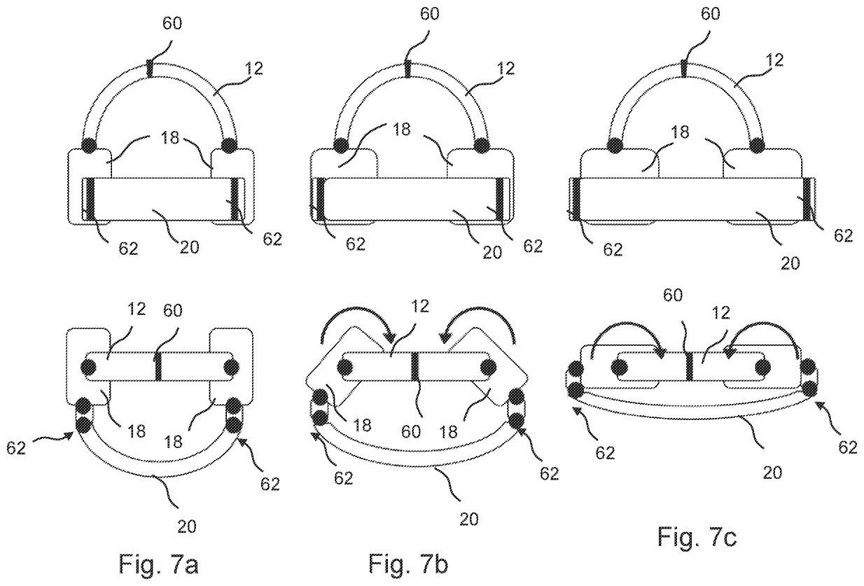

In the examples of the invention discussed above, the flexible regions 52,54 of the headband 12 and air delivery mask 20 are defined as rotational hinges. However, other sorts of hinge mechanisms may be used. Hinge mechanisms as described above are provided in discrete locations and may be embodied as a simple pin-and-barrel arrangement to provides the required pivoting movement. However, other examples are possible. In this respect, FIGS. 5 and 6 show two examples where the flexible region 52,54 is embodied as a living hinge 70,72. Such a living hinge doesn't rely on two connected components rotating with respective to one another like a conventional barrel-type hinge, but rather relies on the inherent resilience of the material to provide the required flexibility.

As shown here, the living hinges in these examples are achieved through lines of weakness 74 such as slots and grooves which has the effect of imparting flexibility to an otherwise stiff material. For example, a rigid plastic rod or bar may be provided with a suitable configuration of slots, grooves or channels in order to provide it with a degree of flexibility.

In the example of FIG. 5, the living hinge 70 is formed from the same material as the parts of the headband 12 or air delivery mask 20 that neighbour the hinge. In contrast, the living hinge 72 depicted in FIG. 6 is formed from a separate component from the neighbouring parts of the headband 12 or air delivery mask 20. In this way, therefore, the materials of the living hinge 70 and the material for the headband/mask as appropriate may each be optimised without the compromise required for flexibility. For example, the living hinge 72 may be made from a relatively flexible silicone rubber, which the headband and mask 20 may be made of stiff material more suited to their respective tasks. Although the hinges are shown here are shown with inherent lines of weakness to impart flexibility, this need not be the case and the required flexibility may be achieved simply by virtue of the material itself providing more flexibility in certain parts of the mask compared to other parts. Since the air delivery mask 20 is formed as a duct for carrying air, the hinges 70 may be also be configured to be hollow so that they allow a flow of air to pass through them. It will be appreciated in these examples that the flexible region extends along a length of the component, whether that component is the mask 20 or the headband 12, rather than being defined at a discrete point, as is the case of a rotational hinge. Therefore, the flexible regions may be distributed along a considerable length of the component in question, which may be great than 30%, or 50% or an even greater proportion of the length of the component.

Various examples have been described above that depict aspects of the invention and variants of it. Other adaptations and modifications to those specific examples would be apparent to the skilled person without departing from the inventive concept as defined by the claims. Two further examples will now be described further below.

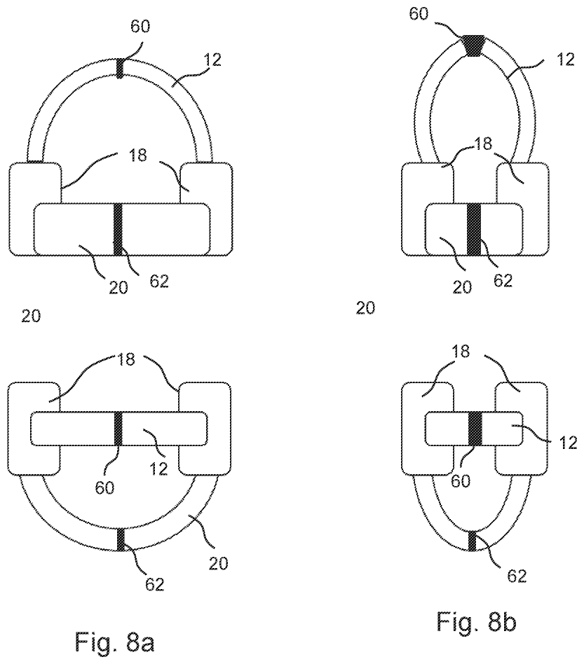

FIGS. 4a-d showed an example of an air purifier having a hinged face mask and a headband and in which the mask folding in on itself, about its centre point, so as to adopt a compact configuration. FIGS. 7a-c show a different example in which the headband has a central hinge, as in the previous example, but the air delivery mask has hinged sections at each of its ends where it connects to the respective earpieces.

Referring firstly to FIG. 7a, the air purifier is shown in the ‘in use’ configuration as would be worn on the head of a user. FIGS. 7b and 7c show the air purifier in two successive stages of folding. In FIG. 7b, it can be seen that the earpieces 18 start to pivot about the ends of the headband 12 which has the effect of somewhat flattening the curved air delivery mask 20. The hinges 62 are on the ends of the air delivery mask 20 in this example and therefore allow the air delivery mask 20 to remain substantially aligned with the headband 12 during folding. As can be seen by FIGS. 7b and 7c, the earpieces 18 pivot through about 90 degrees with respect to the headband 12 so that the plane of the earpieces 18 is approximately aligned with the headband 12. The rotation of the earpieces 18 has the effect of pulling the air delivery mask 20 into a flatter state, so that it adopts a position that is aligned with the earpieces 18 and the headband 12. This results in a significant reduction in the depth of the product, but less of a reduction in its height.

Turning to FIGS. 8a and 8b, in this final example the wearable air purifier resembles closely the example described above with reference to FIGS. 1 and 2. As can be seen, both the headband 12 and the air delivery mask 20 have a centrally positioned hinge, marked as 60 and 62 respectively. Both of the hinged sections therefore impart significant flexibility into the headband. Comparing FIG. 8a with 8b, it will be appreciated that in this example both the headband 12 and the air delivery mask 20 fold in a simple manner such that their respective ends are brought closer together. The earpieces 18 remain in a set orientation throughout the folding movement and the result is a more compact or ‘narrowed’ configuration when viewed from the front.

1. A wearable air purification system comprising:
a wearable support configured to be supported on a head region of a user and having a first end connected to a first audio earpiece and a second end connected to a second audio earpiece;
an air delivery mask in the form of an elongated bar that includes first and second ends connected to the wearable support and which is shaped to bound an air delivery region and to deliver a flow of air to the air delivery region;
wherein the wearable support and the air delivery mask each includes a respective flexible region which allows both the wearable support and the air delivery mask to fold into a compact configuration.

2. The system of claim 1, wherein the first and second ends of the wearable support are connected to the first and second audio earpieces by respective movable couplings.

3. The system of claim 1, wherein the flexible region of the wearable support is defined approximately at the middle of the length of the wearable support.

4. The system of claim 1, wherein the flexible region of the wearable support is located towards one of end of the headband.

5. The system of claim 1, wherein the flexible region of the wearable support is a living hinge.

6. The system of claim 5, wherein the living hinge is of the same material as the adjacent portions of the wearable support.

7. The system of claim 1, wherein the flexible region is a rotating hinge.

8. The system of claim 1, wherein the flexible region defines an air channel.

9. The system of claim 1, wherein the air delivery mask is connected to the wearable support via the first and second audio earpieces.

10. The system of claim 9, wherein the first end of the wearable support is connected to the first audio earpiece and the second end of the wearable support is connected to the second audio earpiece.

11. The system of claim 10, where each end of the air delivery mask is coupled to the respective audio earpiece by a movable coupling.

12. The system of claim 11, wherein at least of the respective movable couplings define at least one respective air channel.

13. The system of claim 10, wherein the flexible region of the air delivery mask is defined approximately in the middle of the air delivery mask between the ends thereof.

14. The system of claim 10, wherein the flexible region of the air delivery mask is located towards at least one of its respective ends.

15. The system of claim 1, wherein the flexible region of the air delivery mask extends across greater than 30% of its length.

16. The system of claim 1, wherein the flexible region of the air delivery mask is a living hinge.

17. The system of claim 16, wherein the living hinge of the air delivery mask is formed of the same material as adjacent portions of the air delivery mask.
